(19) United States
(12) Patent Application Publication
(10) Pub. No.: US 2026/0336131 A1
(43) Pub. Date: Oct. 29, 2026

(54) HANDLING AND SHAPING OF COMPOSITE MEMBERS WITH COLLABORATIVE ROBOT COMPLIANCE IMPLEMENTATION METHOD

(71) Applicant: The Boeing Company, Arlington, VA (US)

(72) Inventors: Luis F. Velasquez, Ladson, SC (US); Edward R. Duncan, Goose Creek, SC (US)

(21) Appl. No.: 19/187,742

(22) Filed: Apr. 23, 2025

(51) Int. Cl. B25J 11/00; B25J 9/16

(52) U.S. Cl. CPC B25J 11/005; B25J 9/1661; B25J 9/1682

(57) ABSTRACT

Methods of shaping, compacting, and forming composite structures are presented. A method of shaping a composite structure is presented. An elongate composite member is held by a plurality of collaborative robots in an initial contour along a length of the elongate composite member. The elongate composite member is placed on a forming surface of a forming tool by the plurality of collaborative robots to form a final contour in the elongate composite member. A desired tension is maintained on at least a portion of the elongate composite member by the plurality of collaborative robots while placing the elongate composite member on the forming surface by at least one collaborative robot of the plurality of collaborative robots automatically moving in response to detecting a tension below a desired threshold.

### BACKGROUND INFORMATION

### 1. Field

The present disclosure relates generally to composite manufacturing and, more particularly, to systems and methods for picking, placing, and shaping uncured elongate composite members.

### 2.Background

A composite structure is typically formed by placing plies or layers of composite material on a forming tool that sets forth the shape and/or contour of the composite structure. Once placed, composite material is then consolidated and/or cured to form the composite structure. However, known techniques for transporting a composite material to a forming tool, placing a composite material on a forming tool, and consolidating a composite material on a forming tool may be labor-intensive and time-consuming. Additionally, depending upon the degree of contour and geometry of the composite structure, special handling may be used to prevent introduction of defects during transfer and placement of the composite material. Accordingly, those skilled in the art continue with research and development efforts in the field of composite manufacturing.

Therefore, it would be desirable to have a method and apparatus that takes into account at least some of the issues discussed above, as well as other possible issues.

### SUMMARY

An embodiment of the present disclosure provides a method of shaping a composite structure. An elongate composite member is held by a plurality of collaborative robots in an initial contour along a length of the elongate composite member. The elongate composite member is placed by the plurality of collaborative robots on a forming surface of a forming tool to form a final contour in the elongate composite member. A desired tension is maintained by the plurality of collaborative robots on at least a portion of the elongate composite member while placing the elongate composite member on the forming surface by at least one collaborative robot of the plurality of collaborative robots automatically moving in response to detecting a tension below a desired threshold.

Another embodiment of the present disclosure provides a method of compacting a composite structure. An end effector is driven by a collaborative robot according to a programmed path. Compaction pressure applied is moderated, based on detected force from force sensors of the collaborative robot, by the end effector to the elongate composite member based on force sensors of the collaborative robot.

Yet another embodiment of the present disclosure provides a method of forming a composite structure. A plurality of collaborative robots holds an elongate composite member in an initial contour along a length of the elongate composite member. The plurality of collaborative robots is moved according to programmed paths for placing the elongate composite member on a forming surface of a forming tool while a human operator is in a manufacturing environment with the plurality of collaborative robots, wherein placing the elongate composite member forms a final contour in the elongate composite member. Forces on the plurality of collaborative robots are continuously monitored during the moving.

Yet another embodiment of the present disclosure provides a method of forming a composite structure. An elongate composite member is formed to a forming surface of a forming tool using a plurality of collaborative robots while a human operator is in a manufacturing environment with the plurality of collaborative robots. Movement of at least one collaborative robot of the plurality of collaborative robots is ceased in response to detecting a force outside of a desired range when the at least one collaborative robot is in contact with the human operator.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of an isometric view of a plurality of automated manipulators holding an elongate composite member in an initial contour in accordance with an illustrative embodiment;

FIG. 4 is an illustration of an isometric view of a plurality of automated manipulators forming an elongate composite member into a final contour in accordance with an illustrative embodiment;

FIG. 5 is an illustration of an isometric view of an elongate composite member having an initial contour in accordance with an illustrative embodiment;

FIG. 6 is an illustration of an isometric view of an elongate composite member having a final contour in accordance with an illustrative embodiment;

FIG. 7 is an illustration of a front view of a programmed path relative to an elongate composite member and a forming tool in accordance with an illustrative embodiment;

FIG. 8 is an illustration of a side view of a programmed path relative to an elongate composite member and a forming tool in accordance with an illustrative embodiment;

FIGS. 9A and 9B are a flowchart of a method of shaping a composite structure in accordance with an illustrative embodiment;

FIG. 10 is a flowchart of a method of compacting a composite structure in accordance with an illustrative embodiment;

FIG. 11 is a flowchart of a method of forming a composite structure in accordance with an illustrative embodiment;

FIG. 12 is a flowchart of a method of forming a composite structure in accordance with an illustrative embodiment;

FIG. 13 is an illustration of an aircraft manufacturing and service method in a form of a block diagram in accordance with an illustrative embodiment; and

FIG. 14 is an illustration of an aircraft in a form of a block diagram in which an illustrative embodiment may be implemented.

### DETAILED DESCRIPTION

The illustrative examples recognize and take into account several considerations. The illustrative examples recognize and take into account that a composite structure can comprise several composite members formed of uncured composite material. The illustrative examples recognize and take into account that handling of uncured composite members while maintaining non-planar cross-sections of the uncured composite members is currently performed using human operators. The illustrative examples recognize and take into account that during an install forming sequence end effectors can apply compaction in a controlled manner at the interaction point between an elongate composite member and the forming tool. The illustrative examples recognize and take into account that compaction in regions between robot end effectors will improve quality of the elongate composite member during installation forming step. The illustrative examples recognize and take into account that the forming rate can vary in regions of high curvature or skin joggles. The illustrative examples recognize and take into account that during an install forming sequence controlling and maintaining the tension in the composite member by proper manipulation of the end effectors will improve quality of the elongate composite member.

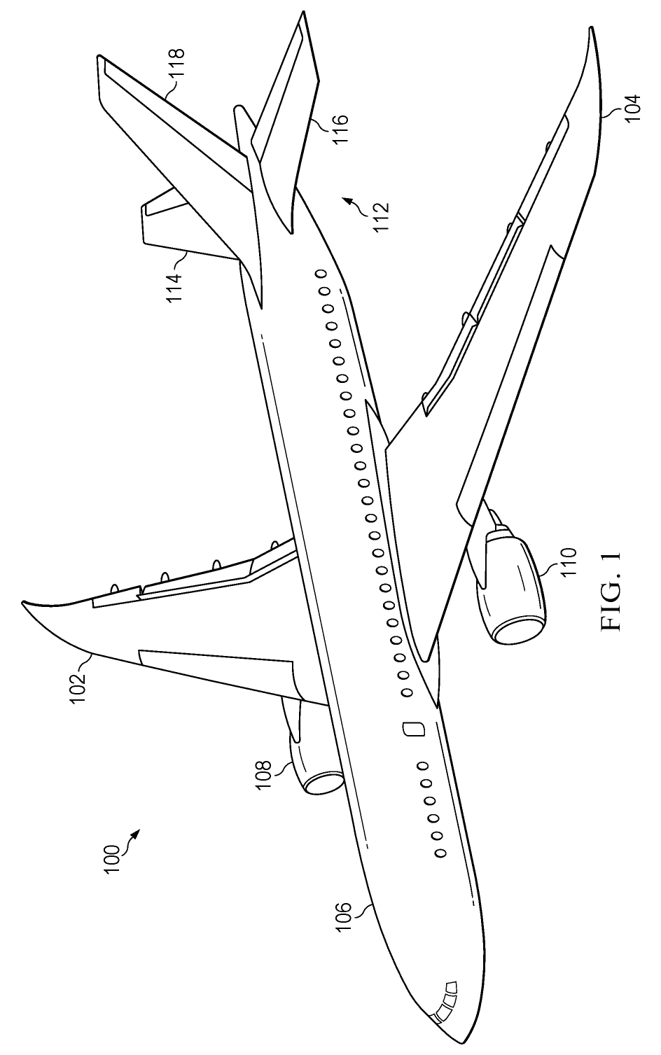

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114 , horizontal stabilizer 116, and vertical stabilizer 118 are attached to tail section 112 of body 106.

Aircraft 100 is an example of an aircraft that can have composite structures formed using collaborative robot compliance methods. For example, a composite stiffener of at least one of wing 102, wing 104, or body 106 can be formed using the methods of the illustrative examples.

Although the illustrative examples are described with respect to an aircraft, an illustrative embodiment may be applied to other types of platforms. The platform may be, for example, a mobile platform, a stationary platform, a land-based structure, an aquatic-based structure, or a space-based structure. More specifically, the platform, may be a surface ship, a tank, a personnel carrier, a train, a spacecraft, a space station, a satellite, a submarine, an automobile, a power plant, a house, a manufacturing facility, a building, a refinery, a chemical containment unit, fuel tank, passenger cabin, or other suitable platforms.

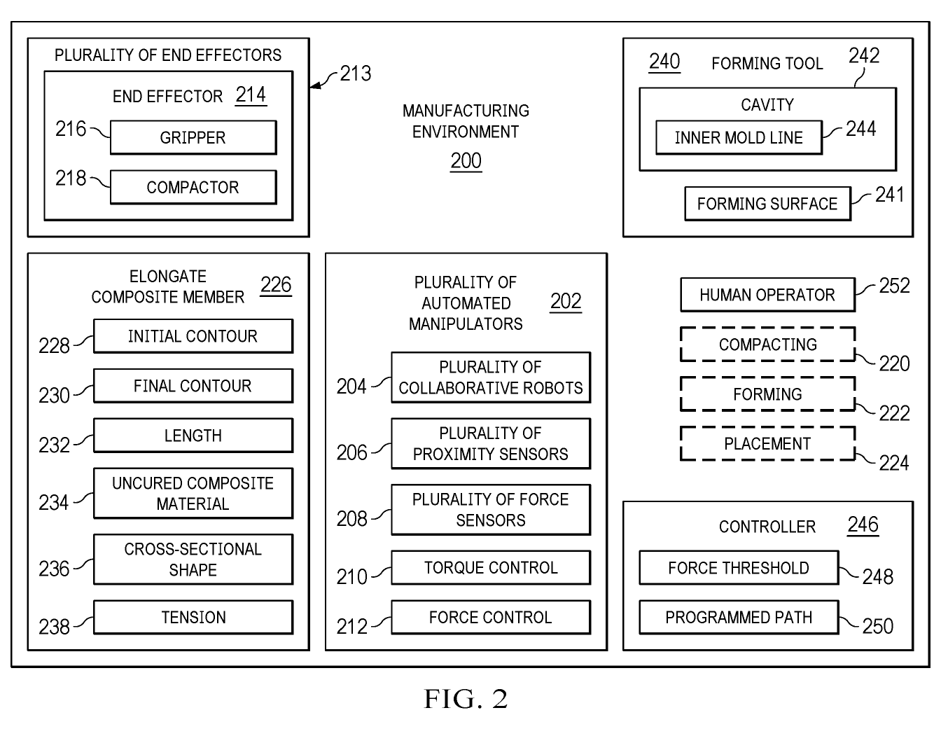

Turning now to FIG. 2, an illustration of a block diagram of a manufacturing environment is depicted in accordance with an illustrative embodiment.

Plurality of automated manipulators 202 are present in manufacturing environment 200. Plurality of automated manipulators 202 can perform placement 224, forming 222, and compacting 220 of elongate composite member 226 against forming tool 240. Placement 224 of elongate composite member 226 moves and places elongate composite member 226 onto forming tool 240. Forming 222 forms elongate composite member 226 against forming tool 240. Prior to forming, elongate composite member 226 has initial contour 228.

Elongate composite member 226 has a relatively high aspect ratio and has length 232 magnitudes of order greater than a width of cross-sectional shape 236. Elongate composite member 226 has initial contour 228. Initial contour 228 refers to a curvature, bend, twist, or shape along a longitudinal axis of elongate composite member 226 prior to picking and placement 224 of elongate composite member 226 on forming tool 240. In some illustrative examples, initial contour 228 is straight or substantially straight. In some illustrative examples, elongate composite member 226 has little to no curvature, bend, or twist along a longitudinal axis of elongate composite member 226. In some illustrative examples, initial contour 228 is not substantially straight and can include a low degree of curvature, bend, or twist along the longitudinal axis of elongate composite member 226. In other examples, the initial contour 228 includes other degrees of curvature, bend, or twist along the longitudinal axis of elongate composite member 226.

After forming 222, elongate composite member 226 has final contour 230 along length 232. In some illustrative examples, final contour 230 comprises at least one of twists, skin joggles, or high curvature. Final contour 230 refers to the curvature, bend, twist, or shape along the longitudinal axis of elongate composite member 226 after forming 222 elongate composite member 226 on forming tool 240. In some illustrative examples, final contour 230 comprises a complex curvature a high degree of curvature, bend, or twist along the longitudinal axis. The degree of curvature, bend, or twist of final contour 230 is dependent on a curvature of the surface of forming tool 240. The degree of curvature, bend, or twist of final contour 230 is dependent on the desired final contour of a composite structure, such as a composite structure of aircraft 100 of FIG. 1. In some illustrative examples, final contour 230 comprises one or more of a lengthwise bend or curvature, a side-to-side bend or curvature, or a twist about the longitudinal axis.

Elongate composite member 226 has cross-sectional shape 236. In some illustrative examples, cross-sectional shape 236 is non-planar. In some illustrative examples, cross-sectional shape 236 is a hat-shaped cross-section. Elongate composite member 226 has cross-sectional shape 236 in both initial contour 228 and final contour 230. End effector 214 can be used for placement 224, forming 222, and compacting 220. End effector 214 is connected to an automated manipulator of plurality of automated manipulators 202. In some illustrative examples, end effector 214 comprises gripper 216 configured to perform picking, placement 224, and forming 222. In some illustrative examples, gripper 216 has a cross-sectional shape configured to accommodate cross-sectional shape 236. In some illustrative examples, end effector 214 comprises compactor 218 configured to perform compacting 220 of elongate composite member 226. In some illustrative examples, compactor 218 has a cross-sectional shape configured to accommodate cross-sectional shape 236.

In some illustrative examples, plurality of automated manipulators 202 comprises plurality of collaborative robots 204. Plurality of collaborative robots 204 have force control 212 and torque control 210 capabilities. Force control 212 and torque control 210 capabilities enable enhanced compacting 220, enhanced forming 222, and enhanced placement 224 of elongate composite member 226. Force control 212 and torque control 210 of plurality of collaborative robots 204 allows for operation of plurality of collaborative robots 204 in manufacturing environment 200 with human operator 252. Collaborative robot compliance features including force control 212 and torque control 210 can be used for lateral self-alignment within elongate composite member 226. The collaborative robot compliance features can be used for applying/controlling lengthwise tension 238 in elongate composite member 226 during a steering sequence.

Plurality of collaborative robots 204 performs placement 224 elongate composite member 226 on forming surface 241 while human operator 252 is in manufacturing environment 200 containing plurality of collaborative robots 204 and forming tool 240. In some illustrative examples, a collaborative robot of plurality of collaborative robots 204 ceases movement in response to detecting a force outside of a desired range. In some illustrative examples, the force is detected by one of plurality of force sensors 208 of plurality of automated manipulators 202. In some illustrative examples, a collaborative robot of plurality of collaborative robots 204 ceases movement in response to detecting a presence of human operator 252 using a proximity sensor of plurality of proximity sensors 206. In some illustrative examples, a collaborative robot of plurality of collaborative robots 204 ceases movement in response to detecting a presence of human operator 252 within reach of the collaborative robot.

Elongate composite member 226 is formed of uncured composite material 234. Uncured composite material 234 is flexible and will have a tendency to droop between grip points. Uncured composite material 234 includes any suitable base materials used in composite manufacturing. Uncured composite material 234 comprises a fiber reinforcement and a matrix. In some illustrative examples, uncured composite material 234 can also include one or more additives, such as, but not limited to, toughening additives, curing agents, binders, or any other desirable additive.

In some illustrative examples, uncured composite material 234 comprises a fiber reinforcement impregnated with a matrix to form a pre-preg. In some illustrative examples, uncured composite material 234 comprises a dry fiber material. The fiber reinforcement comprises carbon fiber, glass fiber, aramid fiber, or any other desirable type of reinforcement material. The fiber reinforcement can be provided in any desirable form, such as woven, nonwoven, fabric, tape, or any other desirable form. The matrix comprises any desirable type of matrix such as a resin, an epoxy, a polymer, or any other desirable type of matrix. The matrix can be thermoplastic or thermoset.

Plurality of automated manipulators 202 enables automated handling of elongate composite member 226. Plurality of automated manipulators 202 apply and control tension 238 in elongate composite member 226 during holding, forming 222, and placement 224. Tension 238 can also be referred to as lengthwise composite member tension. In some illustrative examples, elongate composite member 226 is a composite stiffener, such as a stringer. In these illustrative examples, tension 238 can be referred to as lengthwise stringer tension. Tension 238 is along length 232 of elongate composite member 226. Providing tension 238 provides improved support during handling and steering sequence for elongate composite member 226. Automated handling using plurality of automated manipulators 202, especially plurality of collaborative robots 204, results in more uniform tension 238 in elongate composite member 226. Automated handling using plurality of automated manipulators 202, especially plurality of collaborative robots 204, provides more predictable behavior of elongate composite member 226 between grip points.

Plurality of automated manipulators 202 apply and control compaction force to elongate composite member 226 on the surface of forming tool 240. Force control of plurality of automated manipulators 202 allows the system to adapt to variable tool surface topography and tolerance deviations in forming tool 240.

Use of plurality of automated manipulators 202 enhances accuracy of placement 224, forming 222, and compacting 220 regardless of dimensional tool tolerance errors of forming tool 240 or of tool indexing deviations.

End effectors, including end effector 214, can apply compaction using mechanical rolling, vacuum, or any other desirable method. The end effectors perform compacting 220 in a controlled manner at the interaction point between elongate composite member 226 and forming tool 240. Compaction in regions between robot end effectors attached to plurality of automated manipulators 202 will improve quality during installation forming 222 steps. Rate of forming 222 can vary in regions of high curvature or skin joggles.

Dynamic control of the forces being applied to elongate composite member 226 by plurality of automated manipulators 202 and the motion planning to adapt to changing conditions makes the system more robust, flexible and agile than systems that perform a pre-programmed sequence without deviations. As a result, programmed path 250 for compacting 220 can be positioned within forming tool 240 and compacting 220 can still be performed to a desirable quality. In some illustrative examples, programmed path 250 can be below inner mold line 244 and plurality of automated manipulators 202 can still perform compacting 220. Using plurality of force sensors 208 and force threshold 248, controller 246 can control an amount of compaction applied by plurality of automated manipulators 202. Using plurality of force sensors 208 and force threshold 248 allows an automated manipulator of plurality of automated manipulators 202 to have a driven path deviating from programmed path 250 as the respective automated manipulator attempts to follow programmed path 250 during compacting 220. The driven path may also be referred to as a traveled path. The driven path is the path traversed by the automated manipulator while trying to follow programmed path 250.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, although end effector 214 comprises both gripper 216 and compactor 218, in some illustrative examples, a gripper and a compactor are separate end effectors. As another example, although forming tool 240 is depicted as a female tool with cavity 242, in other illustrative examples, forming tool 240 can have a raised section forming an outer mold line.

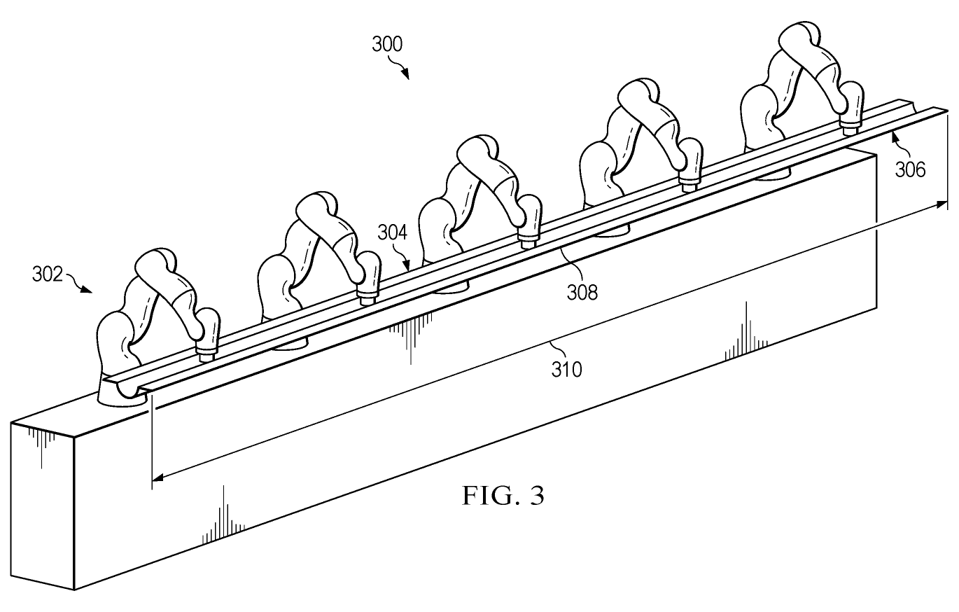

Turning now to FIG. 3, an illustration of an isometric view of a plurality of automated manipulators holding an elongate composite member in an initial contour is depicted in accordance with an illustrative embodiment. Plurality of collaborative robots 302 is a physical implementation of plurality of automated manipulators 202 of FIG. 2. Plurality of collaborative robots 302 can be used to handle and form an elongate composite member of aircraft 100 of FIG. 1. Plurality of collaborative robots 302 can be referred to as plurality of automated manipulators.

In view 300, plurality of collaborative robots 302 is holding elongate composite member 304 in initial contour 306. Plurality of collaborative robots 302 hold unformed portions 308. In this illustrative example, plurality of collaborative robots 302 is distributed across length 310.

In view 300, plurality of collaborative robots 302 has picked up elongate composite member 304 and is moving elongate composite member 304 towards a forming tool (not depicted). While holding elongate composite member 304, plurality of collaborative robots 302 holds elongate composite member 304 in tension. Plurality of collaborative robots 302 holds elongate composite member 304 in tension by monitoring force sensors of plurality of collaborative robots 302. To maintain tension in elongate composite member 304, at least one automated manipulator of plurality of collaborative robots 302 deviates from a programmed path. At least one automated manipulator of plurality of collaborative robots 302 deviates from at least one programmed path of the programmed paths in response to detecting a tension outside of a desired range. In some illustrative examples, at least one automated manipulator can move vertically relative to the manufacturing floor to maintain tension in elongate composite member 304. In some illustrative examples, at least one automated manipulator can move horizontally relative to the manufacturing floor to maintain tension in elongate composite member 304. In some illustrative examples, at least one automated manipulator can move parallel to the length of elongate composite member 304 to maintain tension in elongate composite member 304.

The illustration of a manufacturing environment in view 300 in FIG. 3 is not meant to imply physical or architectural limitations to the manner in which an illustrative embodiment may be implemented. Other components in addition to or in place of the ones illustrated may be used. Some components may be unnecessary. For example, although plurality of collaborative robots 302 is depicted as having five collaborative robots, any desirable quantity of collaborative robots can be utilized. Additionally, although plurality of collaborative robots 302 is depicted as having approximately equal spacing, in some illustrative examples spacing between at least one pair of collaborative robots can be different from spacings between other collaborative robots of plurality of collaborative robots 302.

While handling or transporting elongate composite member 304 in a pre-cure state, elongate composite member 304 is flimsy, non-rigid and susceptible to bending, buckling and twisting. Mishandling can lead to the introduction of wrinkles, bends, or other inconsistencies into elongate composite member 304, or deformation of a cross-section of elongate composite member 304. While handling elongate composite member 304, it is desirable to maintain the cross-sectional shape of elongate composite member 304 and minimize drooping or sagging between grip points provided by plurality of collaborative robots 302. Monitoring and controlling the tension in elongate composite member 304 while optimizing the support spacing provided by plurality of collaborative robots 302 during the handling and forming process enables maintaining the cross-sectional shape of elongate composite member 304.

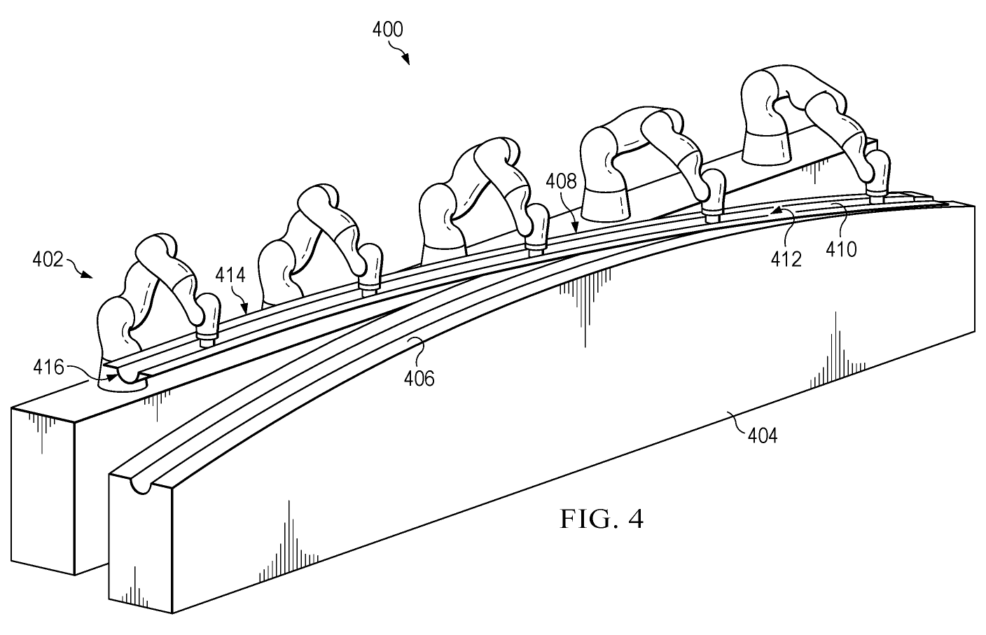

Turning now to FIG. 4 , an illustration of an isometric view of a plurality of automated manipulators forming an elongate composite member into a final contour is depicted in accordance with an illustrative embodiment. In some illustrative examples, plurality of collaborative robots 402 is the same as plurality of collaborative robots 302. Plurality of collaborative robots 402 is a physical implementation of plurality of automated manipulators 202 of FIG. 2. Plurality of collaborative robots 402 can be used to handle and form an elongate composite member of aircraft 100 of FIG. 1. Plurality of collaborative robots 402 can be referred to as plurality of automated manipulators.

In view 400, plurality of collaborative robots 402 is forming elongate composite member 408 onto forming surface 406 of forming tool 404. In this illustrative example, elongate composite member 408 has been partially formed. Formed portions 410 of elongate composite member 408 have final contour 412. Unformed portions 416 of elongate composite member 408 have initial contour 414. In this illustrative example, plurality of collaborative robots 402 maintains tension in elongate composite member 408 during forming of elongate composite member 408 on forming tool 404. As formed portions 410 are placed in contact with forming tool 404, automated manipulators holding unformed portions 416 can deviate from programmed paths to maintain tension in unformed portions 416 of elongate composite member 408.

The illustration of a manufacturing environment in view 400 in FIG. 4 is not meant to imply physical or architectural limitations to the manner in which an illustrative embodiment may be implemented. Other components in addition to or in place of the ones illustrated may be used. Some components may be unnecessary. For example, although plurality of collaborative robots 402 is depicted as having five collaborative robots, any desirable quantity of collaborative robots can be utilized. Additionally, although plurality of collaborative robots 402 is depicted as having approximately equal spacing, in some illustrative examples spacing between at least one pair of collaborative robots can be different from spacings between other collaborative robots of plurality of collaborative robots 402.

While handling or transporting elongate composite member 408 in a pre-cure state, elongate composite member 408 is flimsy, non-rigid and susceptible to bending, buckling and twisting. Mishandling can lead to the introduction of wrinkles, bends, or other inconsistencies into elongate composite member 408, or deformation of a cross-section of elongate composite member 408. While handling elongate composite member 408, it is desirable to maintain the cross-sectional shape of elongate composite member 408 and minimize drooping or sagging between grip points provided by plurality of collaborative robots 402. Monitoring and controlling the tension in elongate composite member 408 while optimizing the support spacing provided by plurality of collaborative robots 402 during the handling and forming process enables maintaining the cross-sectional shape of elongate composite member 408.

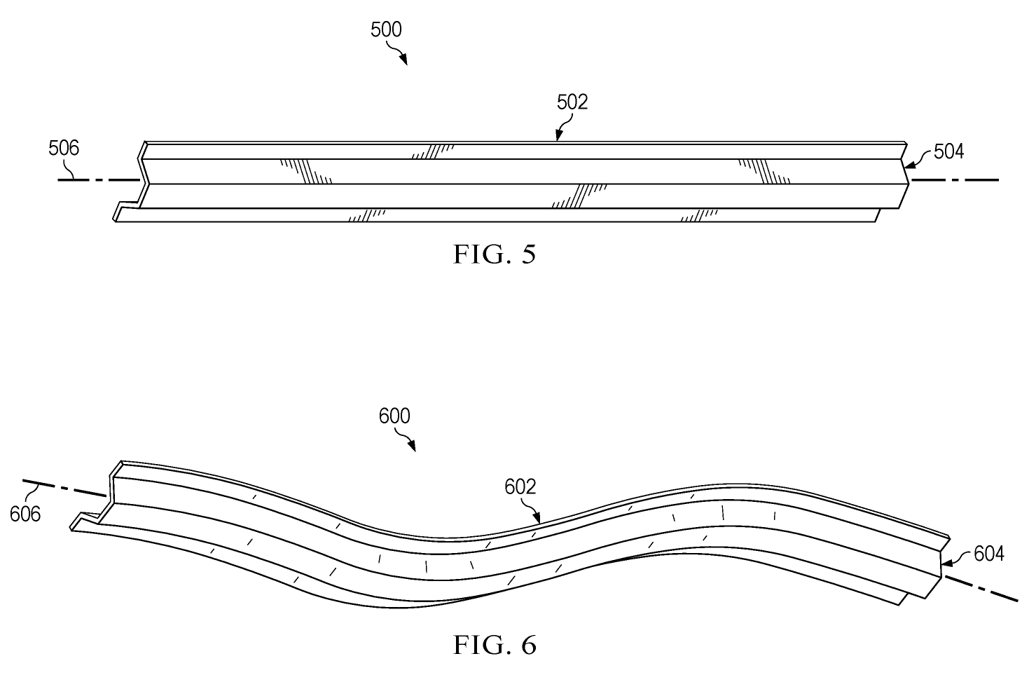

Turning now to FIG. 5 , an illustration of an isometric view of an elongate composite member having an initial contour is depicted in accordance with an illustrative embodiment. In some illustrative examples, elongate composite member 500 is a physical implementation of elongate composite member 226 of FIG. 2. In some illustrative examples, elongate composite member 500 can be used to form a composite stiffener of aircraft 100 of FIG. 1. In some illustrative examples, elongate composite member 500 can be formed by plurality of collaborative robots 302 of FIG. 3. In some illustrative examples, elongate composite member 500 can be formed by plurality of collaborative robots 402 of FIG. 4.

Elongate composite member 500 has initial contour 502 that is substantially straight. In this illustrative example, elongate composite member 500 has cross-sectional shape 504 that is hat-shaped. In other non-depicted examples, elongate composite member 500 comprises a J-shape, an I-shape, a C-shape, or any other desirable cross-sectional shape. Elongate composite member 500 is called an elongate member due to length 506 being substantially longer than a width of cross-sectional shape 504.

Turning now to FIG. 6 , an illustration of an isometric view of an elongate composite member having a final contour is depicted in accordance with an illustrative embodiment. In some illustrative examples, elongate composite member 600 is a physical implementation of elongate composite member 226 of FIG. 2. In some illustrative examples, elongate composite member 600 can be used to form a composite stiffener of aircraft 100 of FIG. 1. In some illustrative examples, elongate composite member 600 can be formed by plurality of collaborative robots 302 of FIG. 3. In some illustrative examples, elongate composite member 600 can be formed by plurality of collaborative robots 402 of FIG. 4. In some illustrative examples, elongate composite member 600 can be elongate composite member 500 with a final contour.

Elongate composite member 600 has been formed from an initial contour into final contour 602. Final contour 602 has a complex curvature. Final contour 602 has vertical curvature along length 606. Elongate composite member 600 has consistent cross-sectional shape 604 throughout length 606. In this illustrative example, cross-sectional shape 604 is a hat shaped cross-section. In other non-depicted examples, cross-sectional shape 604 comprises a J-shape, an I-shape, a C-shape, or any other desirable cross-sectional shape.

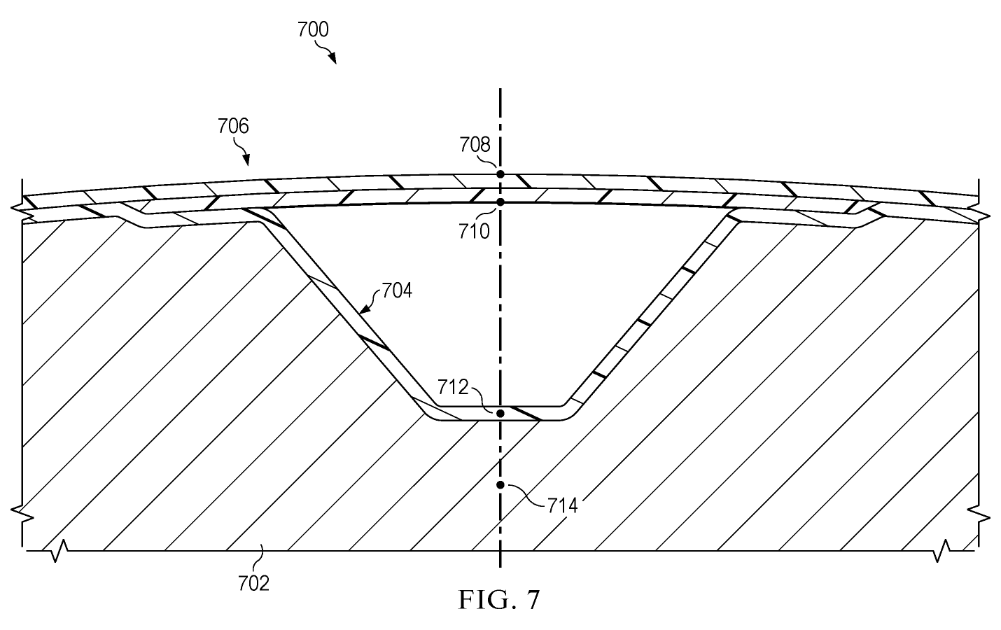

Turning now to FIG. 7 , an illustration of a front view of a programmed path relative to an elongate composite member and a forming tool is depicted in accordance with an illustrative embodiment. Programmed path 714 can be used to form a composite structure of aircraft 100 of FIG. 1. Programmed path 714 can be an example of programmed path 250 of FIG. 2. Programmed path 714 can be an example of a programmed path to form elongate composite member 304. Programmed path 714 can be an example of a programmed path used to form elongate composite member 408. Programmed path 714 can be an example of a programmed path to form elongate composite member 500. Programmed path 714 can be an example of a programmed path used to form elongate composite member 600.

View 700 is through forming tool 702 and composite structure 706 comprising elongate composite member 704. Each of outer mold line 708, elongate composite member surface 710, inner mold line 712, and programmed path 714 are depicted at a centerline through elongate composite member 704. Programmed path 714 is a path that a collaborative robot will attempt to travel in compacting elongate composite member 704 against forming tool 702. Programmed path 714 is positioned below inner mold line 712.

As can be seen in view 700, programmed path 714 is within forming tool 702 and thus cannot be accomplished by the collaborative robot. However, using force sensors, a force threshold, and compliance features, a collaborative robot can perform compacting along a driven path as the collaborative robot attempts to follow programmed path 714.

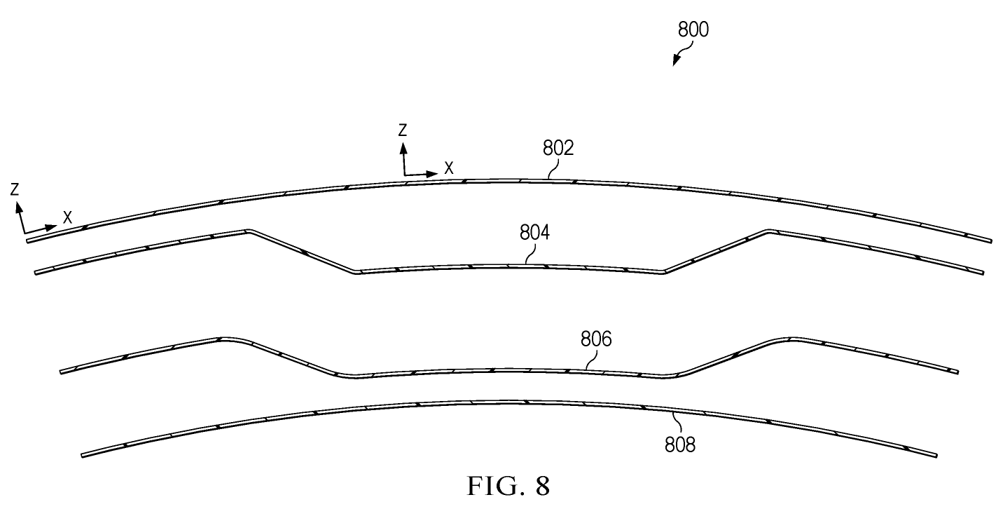

Turning now to FIG. 8 , an illustration of a side view of a programmed path relative to an elongate composite member and a forming tool is depicted in accordance with an illustrative embodiment. Programmed path 808 can be used to form a composite structure of aircraft 100 of FIG. 1. Programmed path 808 can be an example of programmed path 250 of FIG. 2. Programmed path 808 can be followed by an automated manipulator of plurality of collaborative robots 302. Programmed path 808 can be followed by an automated manipulator of plurality of collaborative robots 402. Programmed path 808 can be followed to form elongate composite member 500. Programmed path 808 can be followed to form elongate composite member 600. In some illustrative examples, the lines depicted in view 800 can be the same as the points depicted in FIG. 7.

View 800 is a side view of a programmed path 808 relative to a series of surfaces of a forming tool and an elongate composite member. In this illustrative example, programmed path 808 is below inner mold line 806 of a forming tool (not depicted). In some illustrative examples, programmed path 808 can be the same as programmed path 714 of FIG. 7. To form a final curvature into an elongate composite member, the elongate composite member will be formed against inner mold line 806. In some illustrative examples, inner mold line 806 is the same as inner mold line 712. Surface 804 is an example of a surface of an elongate composite member after forming to inner mold line 806. In some illustrative examples, surface 804 is the same as elongate composite member surface 710. Surface 804 will be formed by driving an end effector along programmed path 808. Outer mold line 802 can be an example of the outer mold line of a composite structure comprising additional composite layers on surface 804 of an elongate composite member. In some illustrative examples, outer mold line 802 is the same as outer mold line 708 of FIG. 7.

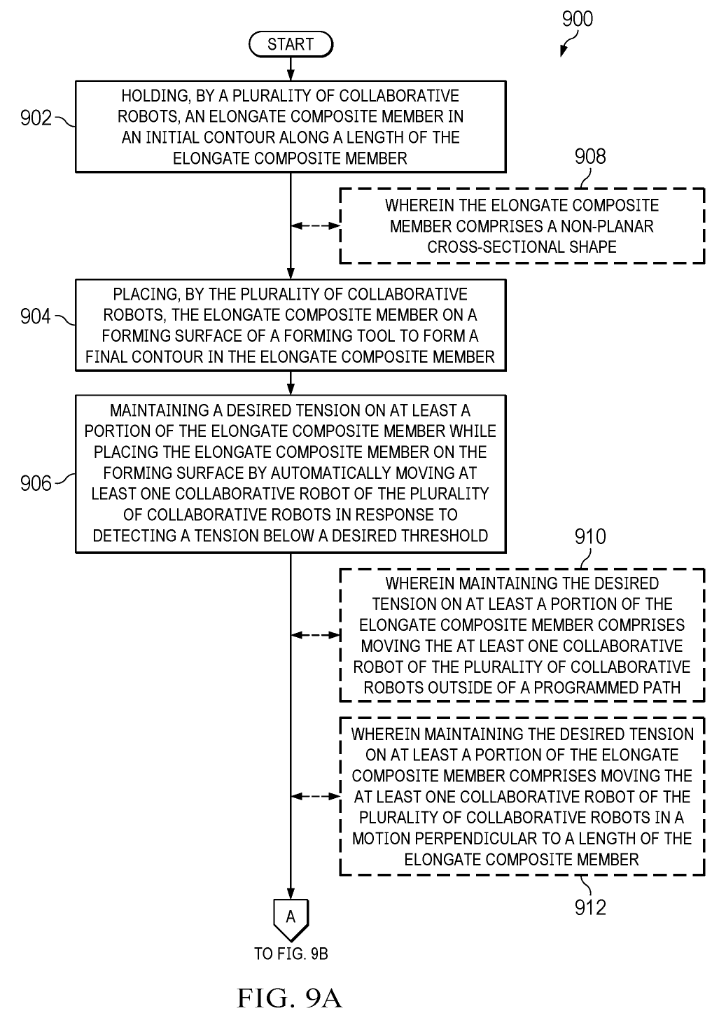

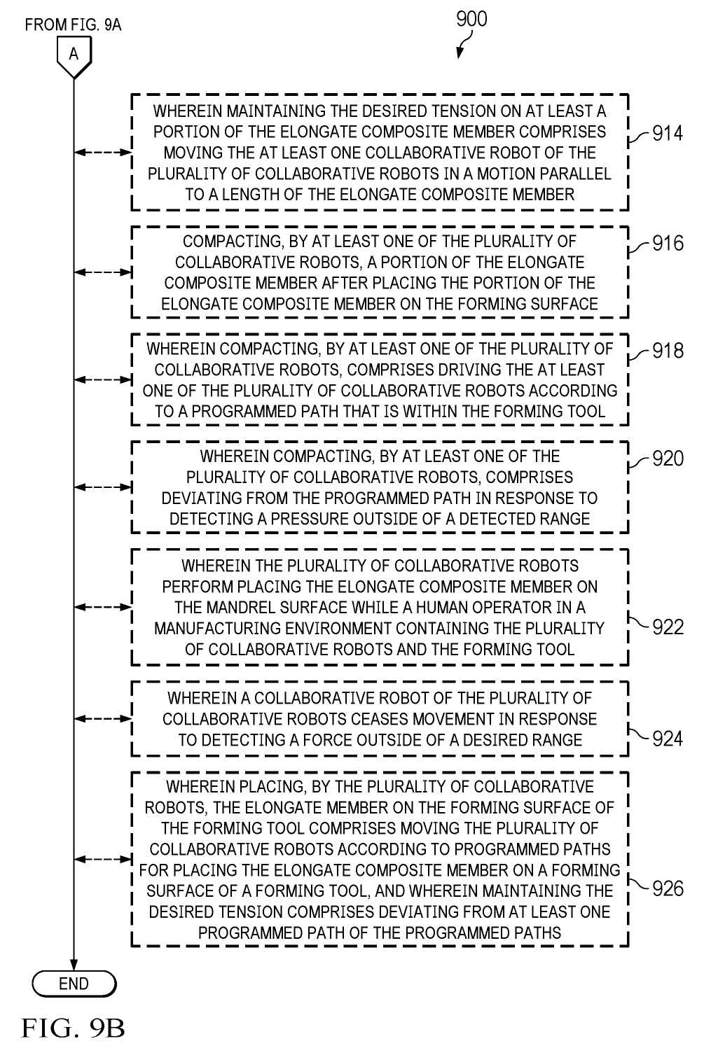

Turning now to FIGS. 9A and 9B, a flowchart of a method of shaping a composite structure is depicted in accordance with an illustrative embodiment. Method 900 can be used to shape a composite structure of aircraft 100 of FIG. 1. Method 900 can be used to shape elongate composite member 226 of FIG. 2. Method 900 can be performed using plurality of collaborative robots 302 of FIG. 3. Method 900 can be performed using plurality of collaborative robots 402 of FIG. 4. Method 900 can be used to shape elongate composite member 500 of FIG. 5. Method 900 could have been used to shape elongate composite member 600 of FIG. 6.

Method 900 holds, by a plurality of collaborative robots, an elongate composite member in an initial contour along a length of the elongate composite member (operation 902). Method 900 places, by the plurality of collaborative robots, the elongate composite member on a forming surface of a forming tool to form a final contour in the elongate composite member (operation 904). Method 900 maintains a desired tension on at least a portion of the elongate composite member while placing the elongate composite member on the forming surface by automatically moving at least one collaborative robot of the plurality of collaborative robots in response to detecting a tension below a desired threshold (operation 906). Afterwards, method 900 terminates.

In some illustrative examples, the elongate composite member comprises a nonplanar cross-sectional shape (operation 908). In some illustrative examples, the elongate composite member comprises a hat-shaped cross-section. In some illustrative examples, the elongate composite member comprises at least one of a C shape cross-section, a J shape cross-section, an L shape cross-section, or a Z shape cross-section.

In some illustrative examples, maintaining the desired tension on at least a portion of the elongate composite member comprises moving the at least one collaborative robot of the plurality of collaborative robots outside of a programmed path (operation 910). In some illustrative examples, maintaining the desired tension on at least a portion of the elongate composite member comprises moving the at least one collaborative robot of the plurality of collaborative robots in a motion perpendicular to a length of the elongate composite member (operation 912). In some illustrative examples, maintaining the desired tension on at least a portion of the elongate composite member comprises moving the at least one collaborative robot of the plurality of collaborative robots in a motion parallel to a length of the elongate composite member (operation 914).

In some illustrative examples, method 900 compacts, by at least one of the plurality of collaborative robots, a portion of the elongate composite member after placing the portion of the elongate composite member on the forming surface (operation 916). In some illustrative examples, compacting, by at least one of the plurality of collaborative robots, comprises driving the at least one of the plurality of collaborative robots according to a programmed path that is within the forming tool (operation 918). In some illustrative examples, compacting, by at least one of the plurality of collaborative robots, comprises deviating from the programmed path in response to detecting a pressure outside of a detected range (operation 920).

In some illustrative examples, the plurality of collaborative robots perform placing the elongate composite member on the forming surface while a human operator is in a manufacturing environment containing the plurality of collaborative robots and the forming tool (operation 922). In some illustrative examples, a collaborative robot of the plurality of collaborative robots ceases movement in response to detecting a force outside of a desired range (operation 924).

In some illustrative examples, placing, by the plurality of collaborative robots, the elongate member on the forming surface of the forming tool comprises moving the plurality of collaborative robots according to programmed paths for placing the elongate composite member on a forming surface of a forming tool, and wherein maintaining the desired tension comprises deviating from at least one programmed path of the programmed paths (operation 926). In some illustrative examples, deviating from at least one programmed path comprises moving a collaborative robot perpendicular to a length of the elongate composite member.

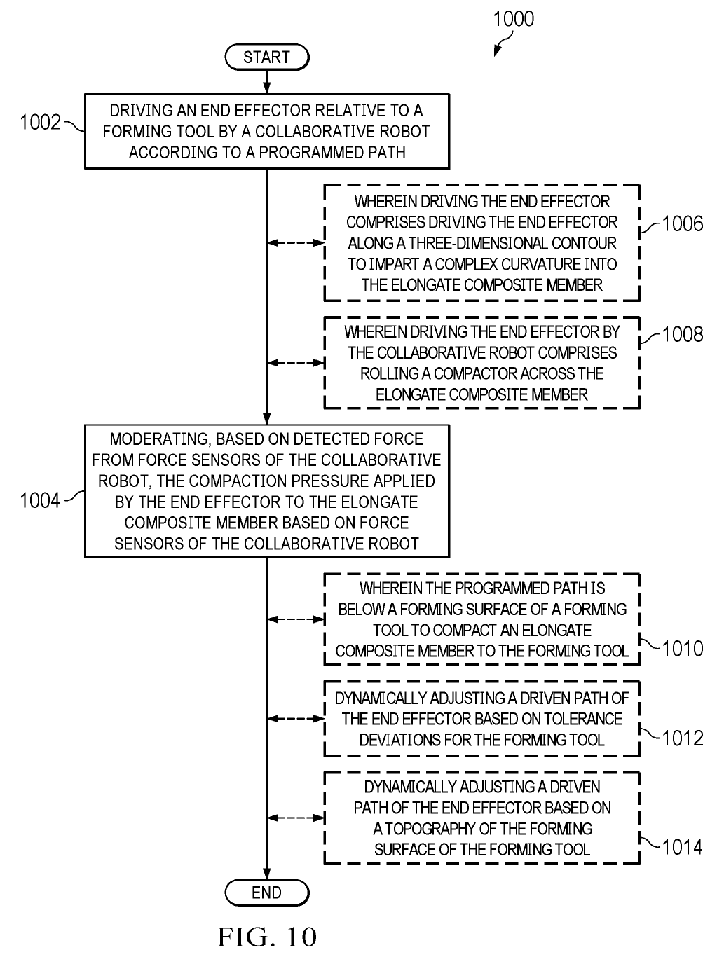

Turning now to FIG. 10, a flowchart of a method of compacting a composite structure is depicted in accordance with an illustrative embodiment. Method 1000 can be used to compact a composite structure of aircraft 100 of FIG. 1. Method 1000 can be used to compact elongate composite member 226 of FIG. 2. Method 1000 can be performed using plurality of collaborative robots 302 of FIG. 3. Method 1000 can be performed using plurality of collaborative robots 402 of FIG. 4. Method 1000 can be used to compact elongate composite member 500 of FIG. 5 after shaping. Method 1000 can be used to compact elongate composite member 600 of FIG. 6.

Method 1000 drives an end effector relative to a forming tool by a collaborative robot according to a programmed path (operation 1002). Method 1000 moderates, based on detected force from force sensors of the collaborative robot, compaction pressure applied by the end effector to the elongate composite member on the forming tool while driving the end effector based on force sensors of the collaborative robot (operation 1004). Afterwards, method 1000 terminates.

In some illustrative examples, method 1000 moderates the force applied based upon the force detected falling outside of set limits. In some illustrative examples, method 1000 moderates the force applied based upon the force detected exceeding set limits. The force applied may exceed set limits if the programmed path is within the forming tool. In some illustrative examples, the force applied may be below set limits if the programmed path is above the forming surface of the forming tool.

In some illustrative examples, driving the end effector comprises driving the end effector along a three-dimensional contour to impart a complex curvature into the elongate composite member (operation 1006). In some illustrative examples, the end effector comprises a roller compactor. In some illustrative examples, driving the end effector by the collaborative robot comprises rolling a compactor across the elongate composite member (operation 1008).

In some illustrative examples, the programmed path is below a forming surface of a forming tool to compact the composite member to the forming tool (operation 1010). In some illustrative examples, the collaborative robot continues attempting to drive the end effector along the programmed path despite the programmed path being below the forming surface.

In some illustrative examples, method 1000 dynamically adjusts a driven path of the end effector based on tolerance deviations for the forming tool (operation 1012). In some illustrative examples, method 1000 dynamically adjusts a driven path of the end effector based on a topography of the forming surface of the forming tool (operation 1014).

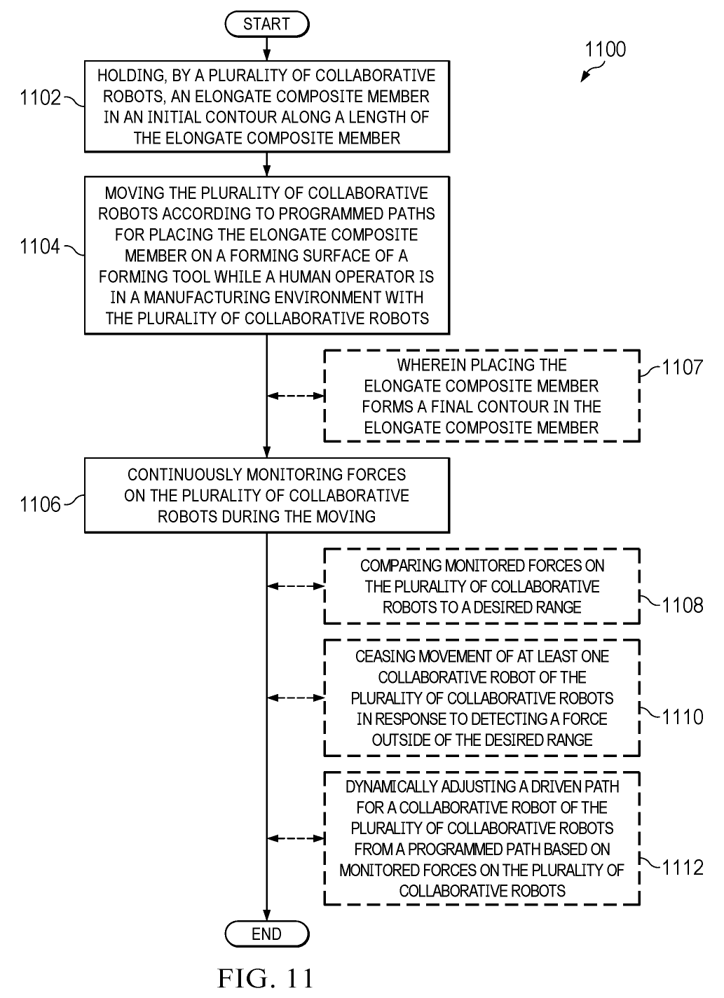

Turning now to FIG. 11, a flowchart of a method of forming a composite structure is depicted in accordance with an illustrative embodiment. Method 1100 can be used to form a composite structure of aircraft 100 of FIG. 1. Method 1100 can be used to form elongate composite member 226 of FIG. 2 into final contour 230. Method 1100 can be performed using plurality of collaborative robots 302 of FIG. 3. Method 1100 can be performed using plurality of collaborative robots 402 of FIG. 4. Method 1100 can be used to form elongate composite member 500 of FIG. 5. Method 1100 can be used to form elongate composite member 600 of FIG. 6.

Method 1100 holds, by a plurality of collaborative robots, an elongate composite member in an initial contour along a length of the elongate composite member (operation 1102). Method 1100 moves the plurality of collaborative robots according to programmed paths for placing the elongate composite member on a forming surface of a forming tool while a human operator is in a manufacturing environment with the plurality of collaborative robots (operation 1104). Method 1100 continuously monitors forces on the plurality of collaborative robots during the moving (operation 1106). Afterwards, method 1100 terminates.

In some illustrative examples, placing the elongate composite member forms a final contour in the elongate composite member (operation 1107). In some illustrative examples, method 1100 compares monitored forces on the plurality of collaborative robots to a desired range (operation 1108). In some illustrative examples, method 1100 ceases movement of at least one collaborative robot of the plurality of collaborative robots in response to detecting a force outside of the desired range (operation 1110).

In some illustrative examples, method 1100 dynamically adjusts a driven path for a collaborative robot of the plurality of collaborative robots from a programmed path based on monitored forces on the plurality of collaborative robots (operation 1112).

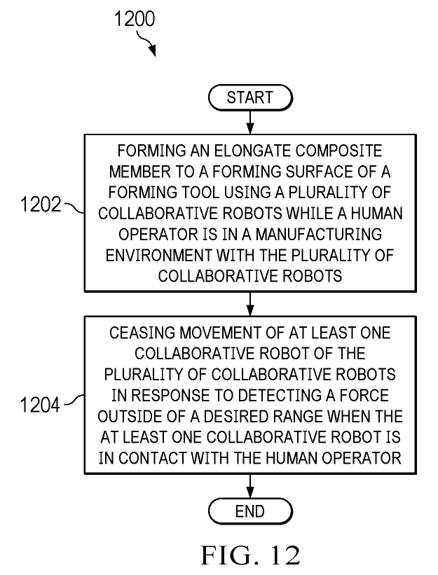

Turning now to FIG. 12, a flowchart of a method of forming a composite structure is depicted in accordance with an illustrative embodiment. Method 1200 can be used to form a composite structure of aircraft 100 of FIG. 1. Method 1200 can be used to form elongate composite member 226 of FIG. 2 into final contour 230. Method 1200 can be performed using plurality of collaborative robots 302 of FIG. 3. Method 1200 can be performed using plurality of collaborative robots 402 of FIG. 4. Method 1200 can be used to form elongate composite member 500 of FIG. 5. Method 1200 can be used to form elongate composite member 600 of FIG. 6.

Method 1200 forms an elongate composite member to a forming surface of a forming tool using a plurality of collaborative robots while a human operator is in a manufacturing environment with the plurality of collaborative robots (operation 1202). Method 1200 ceases movement of at least one collaborative robot of the plurality of collaborative robots in response to detecting a force outside of a desired range when the at least one collaborative robot is in contact with the human operator (operation 1204). Afterwards, method 1200 terminates.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 908 through operation 926 may be optional. As another example, operation 1006 through operation 1014 may be optional. As another example, operation 1108 through operation 1112 may be optional.

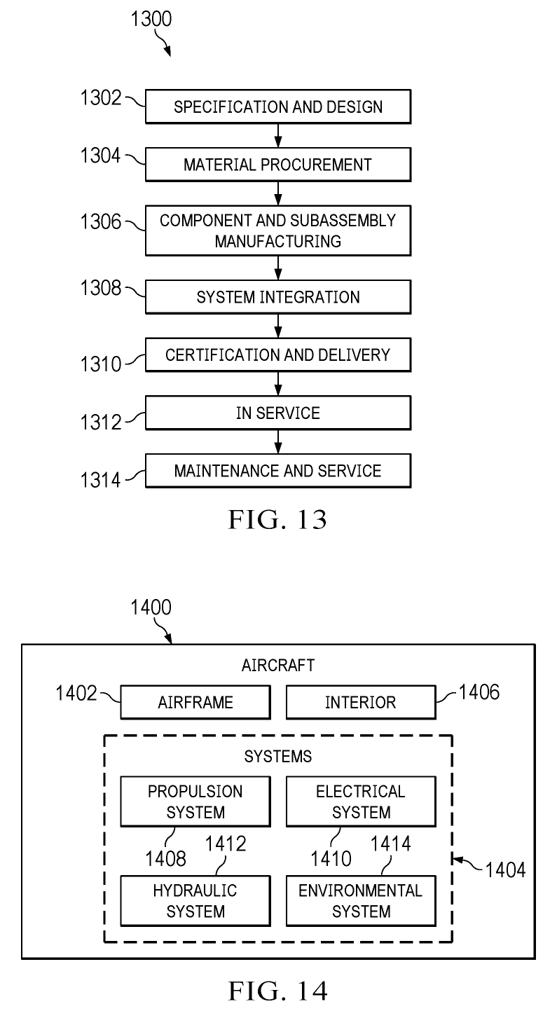

Illustrative embodiments of the present disclosure may be described in the context of aircraft manufacturing and service method 1300 as shown in FIG. 13 and aircraft 1400 as shown in FIG. 14. Turning first to FIG. 13, an illustration of an aircraft manufacturing and service method in a form of a block diagram is depicted in accordance with an illustrative embodiment. During pre-production, aircraft manufacturing and service method 1300 may include specification and design 1302 of aircraft 1400 in FIG. 14 and material procurement 1304.

During production, component and subassembly manufacturing 1306 and system integration 1308 of aircraft 1400 takes place. Thereafter, aircraft 1400 may go through certification and delivery 1310 in order to be placed in service 1312. While in service 1312 by a customer, aircraft 1400 is scheduled for routine maintenance and service 1314, which may include modification, reconfiguration, refurbishment, or other maintenance and service.

Each of the processes of aircraft manufacturing and service method 1300 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 14, an illustration of an aircraft in a form of a block diagram is depicted in which an illustrative embodiment may be implemented. In this example, aircraft 1400 is produced by aircraft manufacturing and service method 1300 of FIG. 13 and may include airframe 1402 with plurality of systems 1404 and interior 1406. Examples of systems 1404 include one or more of propulsion system 1408, electrical system 1410, hydraulic system 1412, and environmental system 1414. Any number of other systems may be included.

Apparatuses and methods embodied herein may be employed during at least one of the stages of aircraft manufacturing and service method 1300. One or more illustrative embodiments may be manufactured or used during at least one of component and subassembly manufacturing 1306, system integration 1308, in service 1312, or maintenance and service 1314 of FIG. 13.

The illustrative examples enables a human operator to work near robots. In the illustrative examples, a sensing mechanism within the robot senses the force that the robot is applying. In the illustrative examples, when a force threshold is reached, the operation creating the force overload is stopped. Stopping the operation creating the force overload will deactivate the robot from contacting a human operator with force above the force threshold.

The illustrative examples utilize collaborative robots with force control and torque control for applying and controlling compaction force to the elongate composite member, such as a stringer, on the forming surface of the forming tool. The illustrative examples, the system is agnostic to tool surface topography by using force control and torque control. Additionally, collaborative robot compliance can be used for lateral self-alignment within an elongate composite member. The collaborative robot compliance can be used for applying/controlling lengthwise tension in the elongate composite member during steering sequence. Tension is part of the forming process and may be part of the pick, transport and place process. The illustrative examples can reduce drooping of the elongate composite member between the end effectors. The illustrative examples can optimize system accuracy regardless of dimensional tool tolerance errors

The illustrative examples provide adequate support of an elongate composite member formed of an uncured composite material. The illustrative examples provide accurate coordination of handlers for an elongate composite member during an installation and forming sequence of the elongate composite member.

The illustrative examples increase process repeatability and process reliability. The illustrative examples can improve cycle rate control. The illustrative examples can accommodate heat usage during forming of an elongate composite member. In some illustrative examples, the system can reduce heat usage during forming of an elongate composite member.

The illustrative examples can improve quality of elongate composite structures through at least one of improved handling, improved forming, and improved compaction. The illustrative examples can automate greater percentages of composite forming. The illustrative examples can reduce the use of human operators in composite manufacturing. Using the force, torque and compliance features of the collaborative robots helps to ensure part quality, limit handling inconsistencies such as wrinkles or bends, and ensure placement accuracy of member onto tool.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of shaping a composite structure comprising:
holding, by a plurality of collaborative robots, an elongate composite member in an initial contour along a length of the elongate composite member;
placing, by the plurality of collaborative robots, the elongate composite member on a forming surface of a forming tool to form a final contour in the elongate composite member; and
maintaining a desired tension on at least a portion of the elongate composite member while placing the elongate composite member on the forming surface by automatically moving at least one collaborative robot of the plurality of collaborative robots in response to detecting a tension below a desired threshold.

2. The method of claim 1, wherein maintaining the desired tension on at least a portion of the elongate composite member comprises moving at the least one collaborative robot of the plurality of collaborative robots outside of a programmed path.

3. The method of claim 1, wherein maintaining the desired tension on at least a portion of the elongate composite member comprises moving the at least one collaborative robot of the plurality of collaborative robots in a motion perpendicular to a length of the elongate composite member.

4. The method of claim 1, wherein maintaining the desired tension on at least a portion of the elongate composite member comprises moving the at least one collaborative robot of the plurality of collaborative robots in a motion parallel to a length of the elongate composite member.

5. The method of claim 1, wherein the elongate composite member comprises a nonplanar cross-sectional shape.

6. The method of claim 1 further comprising:
compacting, by at least one of the plurality of collaborative robots, a portion of the elongate composite member after placing the portion of the elongate composite member on the forming surface.

7. The method of claim 6, wherein compacting, by at least one of the plurality of collaborative robots, comprises driving the at least one of the plurality of collaborative robots according to a programmed path that is within the forming tool.

8. The method of claim 6, wherein compacting, by at least one of the plurality of collaborative robots, comprises deviating from a programmed path in response to detecting a pressure outside of a detected range.

9. The method of claim 1, wherein the plurality of collaborative robots perform placing the elongate composite member on the forming surface while a human operator is in a manufacturing environment containing the plurality of collaborative robots and the forming tool.

10. The method of claim 9, wherein a collaborative robot of the plurality of collaborative robots ceases movement in response to detecting a force outside of a desired range.

11. The method of claim 1, wherein placing, by the plurality of collaborative robots, the elongate composite member on the forming surface of the forming tool comprises moving the plurality of collaborative robots according to programmed paths for placing the elongate composite member on a forming surface of a forming tool, and wherein maintaining the desired tension comprises deviating from at least one programmed path of the programmed paths.

12. A method of compacting an elongate composite member comprising:
driving an end effector relative to a forming tool by a collaborative robot according to a programmed path; and
moderating, based on detected force from force sensors of the collaborative robot, compaction pressure applied by the end effector to the elongate composite member on the forming tool while driving the end effector .

13. The method of claim 12, wherein the programmed path is below a forming surface of the forming tool to compact the elongate composite member to the forming tool.

14. The method of claim 12 further comprising:
dynamically adjusting a driven path of the end effector based on tolerance deviations for the forming tool.

15. The method of claim 12 further comprising:
dynamically adjusting a driven path of the end effector based on a topography of a forming surface of the forming tool.

16. The method of claim 12, wherein driving the end effector comprises driving the end effector along a three-dimensional contour to impart a complex curvature into the elongate composite member.

17. The method of claim 12, wherein driving the end effector by the collaborative robot comprises rolling a compactor across the elongate composite member.

18. A method of forming a composite structure comprising:
holding, by a plurality of collaborative robots, an elongate composite member in an initial contour along a length of the elongate composite member;
moving the plurality of collaborative robots according to programmed paths for placing the elongate composite member on a forming surface of a forming tool while a human operator is in a manufacturing environment with the plurality of collaborative robots; and
continuously monitoring forces on the plurality of collaborative robots during the moving.

19. The method of claim 18 further comprising:
comparing monitored forces on the plurality of collaborative robots to a desired range; and
ceasing movement of at least one collaborative robot of the plurality of collaborative robots in response to detecting a force outside of the desired range.

20. The method of claim 18 further comprising:
dynamically adjusting a driven path for a collaborative robot of the plurality of collaborative robots from a programmed path based on monitored forces on the plurality of collaborative robots.

21. The method of claim 18, wherein placing the elongate composite member forms a final contour in the elongate composite member.

22. A method of forming a composite structure comprising:
forming an elongate composite member to a forming surface of a forming tool using a plurality of collaborative robots while a human operator is in a manufacturing environment with the plurality of collaborative robots; and
ceasing movement of at least one collaborative robot of the plurality of collaborative robots in response to detecting a force outside of a desired range when the at least one collaborative robot is in contact with the human operator.
